(19) United States
(12) Patent Application Publication
(10) Pub. No.: US 2002/0046714 A1
(43) Pub. Date: Apr. 25, 2002

(54) Automotive pet restraint

(76) Inventor: Eric Jason Simmons, Nederland, TX (US)

Correspondence Address: ERIC SIMMONS, P.O. BOX 102, NEDERLAND, TX, 77627, US

(21) Appl. No.: 09/966,169

(22) Filed: Sep. 28, 2001

Related U.S. Application Data
(60) Provisional application No. 60/236,535, filed on Sep. 29, 2000.

(51) Int. Cl. B60R 22/12; B60R 22/34

(52) U.S. Cl. 119/771

(57) ABSTRACT

A universal animal restraining device for use in automobiles, trucks, trucks, R.V.'s, trailers, the home, outdoors or anywhere that will accept a 1¾″ diameter×⅜″ in height, round mounting base, with a quick release fitting and a plastic coated wire rope leash. The leash/fitting assembly may be easily removed, leaving only a low profile mounting base in place.

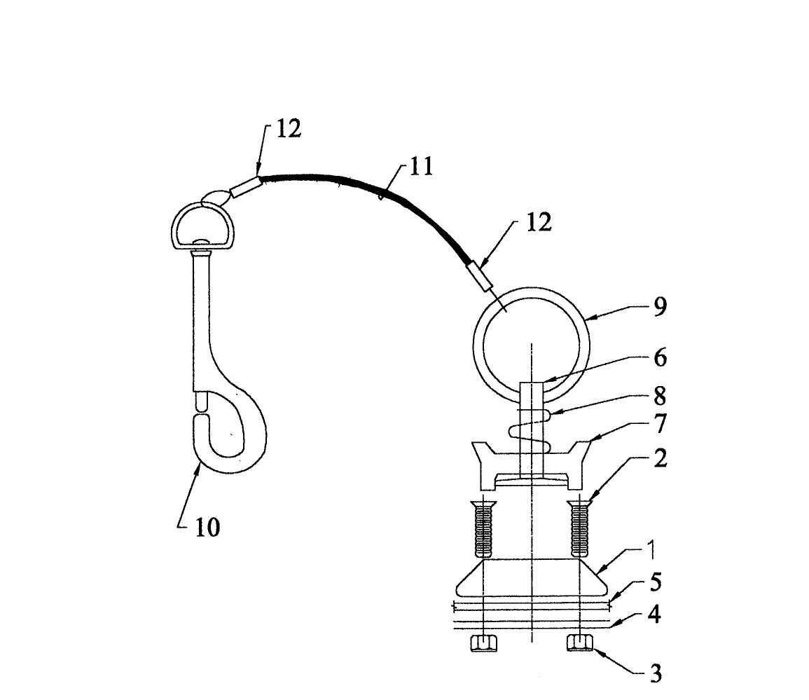

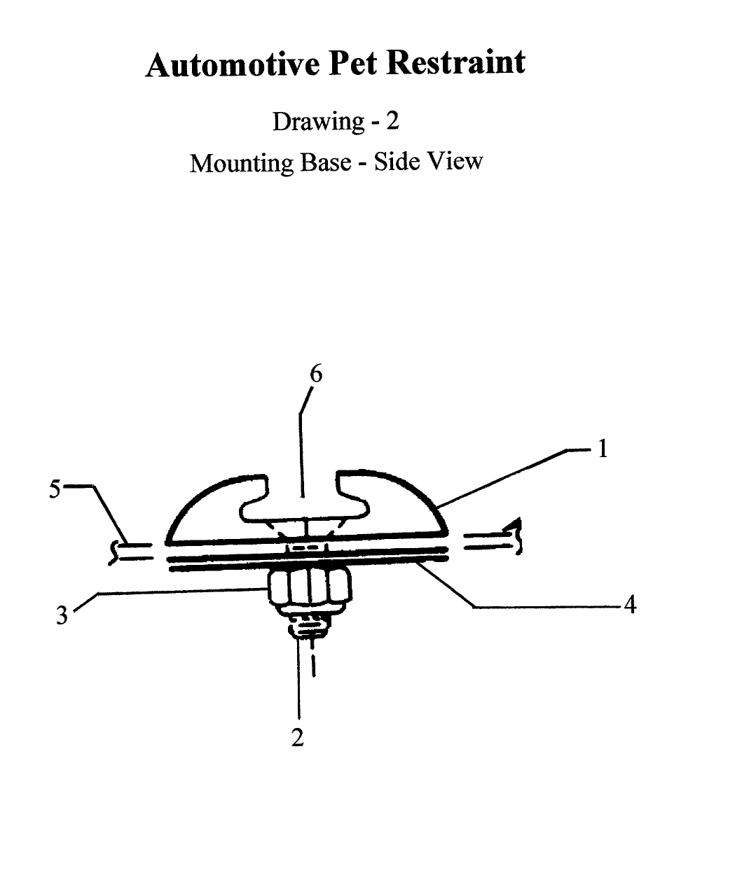

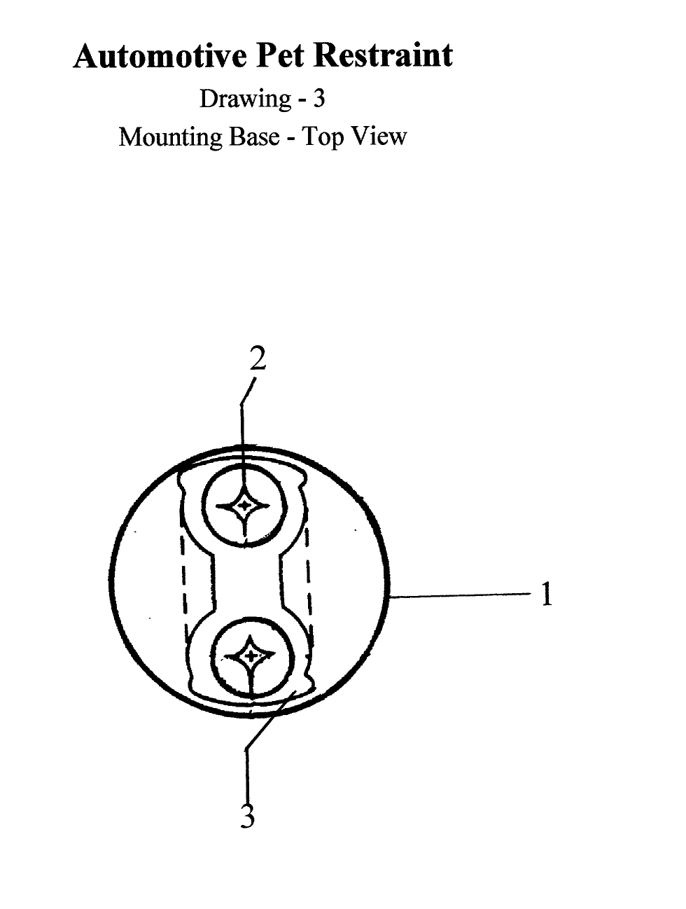

### BACKGROUND OF INVENTION

The invention relates to a leash and mounting attachment for any type of pet restraint application. However, it is more specifically designed for use in automobiles to prevent a pet from roaming loose in the interior of a car or jumping or being thrown or blown from the bed of a pick-up truck

### DESCRIPTIONS OF THE PRIOR ART

The uses of safety leashes for pets in automobiles are known in the prior art, which are noted in the above cross-references. However, these prior patents have been designed for very specific applications. Notably, these prior applications were invented with the idea of restraining the pet exclusively inside of an automobile or restraining the pet exclusively in the cargo bed of a truck. The present invention however, is universal and may be used in automobile interiors, the cargo beds of trucks, in the home, outdoors or anywhere that will accept the 1¾″ diameter, round mounting base. Furthermore, because of this inventions small size, it does not interfere with the normal use of automobile interiors or the cargo capacity of the cargo bed, as the above cross-referenced inventions have the tendency to do. Ease of installation and operation are another advantage over past inventions of this type.

### SUMMARY OF THE INVENTION

The present invention is designed to restrain or limit the movement of pets or other animals. Unlike similar inventions in the past, the present invention is meant to be universal in its use, limited only to the users imagination. A small mounting base is permanently attached in the desired location. A fitting/leash assembly can then be readily installed or removed at the user's discretion. This assembly may be installed within the interior of any type of automobile, in the cargo bed of any truck, on any accessible surface of any type of trailer, anywhere in the home or any place that will accept the 1¾″ diameter, round mounting base.

### DESCRIPTION OF DRAWINGS

### Drawing 1

Drawing 1 is an overall view of the invention with reference numbers as follows:

1) Mounting Base.

2) ¼″ 100 degree countersink flathead bolt with 28 threads per inch.

3) ¼″ self-locking hex-head nut with 28 threads per inch.

4) Backing plate/washer.

5) Mounting surface.

6) ⅜″×¾″ carbon steel stud, 1¼″ in length, cadmium plated.

7) 1″×¾″ carbon steel retainer, cadmium plated.

8) 316 stainless steel compression spring.

9) 1½″ stainless steel ring.

10) ½″ swivel snap bolt.

11) 3/32″ galvanized wire rope cable, plastic coated to 3/16″, with a ½″ eye on both ends. Length is dependant on the specific application.

12) 3/32″ aluminum duplex sleeve.

### Drawing 2

Drawing 2 is a side view of the installed mounting base with ref numbers as follows:

1) Mounting base.

2) ¼″ 100 degree countersink flathead bolt with 28 threads per inch.

3) ¼″ self-locking hex-head nut with 28 threads per inch.

4) Backing plate/washer.

5) Mounting surface.

6) 7/16×¾″ “T” shaped groove.

### Drawing 3

Drawing 3 is a top view of the installed mounting base with ref. numbers as follows:

1) Mounting base.

2) ¼″ 100 degree countersink flathead bolt with 28 threads per inch.

3) 7/16″×¾″ “T” shaped groove.

### DESCRIPTION OF THE INVENTION

All ref Numbers relate to Drawing 1 unless otherwise noted. The mounting base (ref. No. 1) is secured to the automobile, in the home or anywhere deemed necessary by the user using two (2) ¼″-28, 100° countersunk, flathead bolts of the desired length, (ref. no. 2) and held in place by two (2) ¼″ self-locking hex-head nuts, (ref. no. 3) or two standard 3/16″, countersunk, flathead wood screws, or an epoxy adhesive (not shown), depending upon the application. A steel backing plate/washer (ref. no. 4) is installed between the mounting surface (ref. no. 5) and the self-locking nuts, where needed for added strength. The mounting base is manufactured from 7076 T-6 aircraft aluminum. It is 1¾″ in diameter and ⅜″ in height. A “T” shaped groove which is ¾″ at the bottom and 7/16″ at the top, is cut through the mounting base (see Drawing 2-ref. no. 6 and Drawing 3-ref. no. 3) to accept a cadmium plated carbon steel stud (ref. no. 6). The groove is enlarged on each end (see Drawing 3-ref. no. 3) to accept a spring-loaded cadmium plated, carbon steel retainer (ref. no. 7). The cadmium plated stud aligns with the groove in the mounting base, while the spring-loaded cadmium plated retainer locks the stud into place. The stud rotates freely 360° to prevent the pet from becoming entangled in the leash. The stud/base assembly has a load rating of 4000 psi. A 1½″ stainless steel ring (ref. no. 9) is attached to the stud by means of a 3/16″ hole drilled through the stud which the 1½″ stainless steel ring passes through. This 1½″ stainless steel ring is welded together at the end for added strength. A ½″ swivel snap bolt (ref. no. 10) is connected to the stainless steel ring by a 3/32″ diameter galvanized wire rope cable, (ref. no. 11), which is plastic coated to 3/16″. The purpose in using wire rope is to prevent pets/animals from chewing through the leash. The purpose of the plastic coating is to prevent injury to the pet/animal and to avoid damage to the automobile finish or other surrounding areas. The wire rope leash is connected to the stainless steel ring on one end, and to the ½″ swivel snap bolt on the other end by making an eye on both ends of the 3/32″ wire rope using 3/32″ aluminum duplex sleeves (ref. no. 12). This is a permanent connection. Three (3) inches of the plastic coating of the wire rope is removed or stripped from both ends of the wire rope before the aluminum duplex sleeves are crimped into place for a more secure connection, and therefore more strength. The ½″ snap bolt also swivels 360° to prevent the pet/animal from becoming entangled in the leash. The stud, retainer, 1½″ stainless steel ring and stainless steel compression spring make up the tie-down fitting. By grasping the fitting's retainer between the index and middle fingers and depressing the stud with the thumb, the fitting/leash assembly is easily inserted into the mounting base. In the same manner, the fitting/leash assembly is just as easily removed from the mounting base and is small enough to be stowed anywhere in the vehicle or home. This leaves only the low profile mounting base in place, which will not interfere with the normal use of the automobile interior or the cargo capacity of the bed, and is inconspicuous in the home. Once the fitting/leash assembly is installed in the base, the ½″ swivel snap bolt may be connected to any standard pet collar, securely restraining the animal.

1) Besides the need to prevent a pet/animal from jumping, being blown or thrown from the bed of a truck, there is also the problem of loose animals in the driver's compartment of any type of vehicle, distracting the driver, which endangers the vehicle's occupants, other motorists and the pet itself. This invention eliminates all of these problems by an economical, easily installed, easily maintained and universal means which is described in greater detail in the “Description of the Invention”.

2) An animal restraining device with a quick release leash leaving only a low profile mounting base when the leash is removed if not needed, with the base being only 1¾″ in diameter and ⅜″ in height.

3) Leash is included and is made of wire rope to prevent animals from chewing through the leash to escape.

4) Invention is universal and may be attached in automobiles, trucks, R.V.'s, trailers, airplanes, boats, inside the home, outdoors or anywhere that will accept the 1¾″ diameter×⅜″ in height, round mounting base.

5) The invention is extremely user friendly.

6) The animal is allowed freedom of movement, but this movement is limited to the length of the leash, which can be manufactured to any length desired depending upon the application.

7) The leash is manufactured from wire rope cable, which is galvanized and plastic coated. This prevents the animal from chewing through the leash and escaping, which has been a problem with conventional leashes in the past. The leash is both plastic coated and galvanized to prevent corrosion. The plastic coating further prevents injury to the pet and avoids damage to surfaces surrounding the mounting area.

8) The leash/fitting assembly can be removed in seconds leaving only the unobtrusive, low profile mounting base.
